(19) United States
(12) Patent Application Publication
(10) Pub. No.: US 2025/0354003 A1
(43) Pub. Date: Nov. 20, 2025

(54) THERMOPLASTIC ELASTOMER COMPOSITION AND MOLDED PRODUCT THEREOF

(71) Applicants: Hyundai Motor Company, Seoul (KR); Kia Corporation, Seoul (KR); HWASEUNG CORPORATION CO., LTD, Busan (KR)

(72) Inventors: Ji Hye Park, Hwaseong (KR); Ho Dong Kim, Hwaseong (KR); Joon Chul Park, Hwaseong (KR); So Hyun Park, Yangsan (KR); Sang Hyun Lee, Yangsan (KR); Kyoung Min Hong, Yangsan (KR)

(21) Appl. No.: 18/937,750

(22) Filed: Nov. 5, 2024

(30) Foreign Application Priority Data
May 14, 2024 (KR) 10-2024-0063477

(51) Int. Cl. C08L 23/16; C08K 5/20; C08K 5/5419

(52) U.S. Cl. CPC C08L 23/16; C08K 5/20; C08K 5/5419; C08L 2207/04

(57) ABSTRACT

A thermoplastic elastomer composition, which shows higher double-injection property with the PP, lower hardness, and the lower change in the storage modulus at the lower temperature, is prepared by mixing a proper content of a siloxane-based additive, a slip agent in a thermoplastic elastomer and a thermoplastic vulcanizate (TPV). The siloxane-based additive and slip agent are optimized to improve processability and mechanical properties, while the TPV component, including an ethylene propylene diene monomer (EPDM) and polypropylene resin, contributes to enhanced elasticity and stability. The formulation balances flexibility and strength, with siloxane additives improving surface characteristics and the slip agent reducing friction. The composition is suitable for various applications requiring robust elastomeric performance, especially in molded products where low-temperature resilience and high processability are critical. The overall polypropylene content is controlled to ensure optimal performance, not exceeding 5 wt %.

### CROSS-REFERENCE TO RELATED APPLICATION

This application claims under 35 U.S.C. § 119(a) the benefit of Korean Patent Application No. 10-2024-0063477, filed in the Korean Intellectual Property Office on May 14, 2024, the entire contents of which are incorporated herein by reference.

### BACKGROUND

### Technical Field

The present disclosure relates to a thermoplastic elastomer composition and a molded product including the same, and more particularly relates to a rubber seal of an outside mirror of a vehicle. The disclosed thermoplastic elastomer composition is designed to provide enhanced performance characteristics such as improved flexibility, weather resistance, and reduced coefficient of friction, making it particularly suitable for automotive applications. These compositions are beneficial for producing seals, gaskets, and other components that require a combination of elastomeric properties and ease of processing associated with thermoplastics. The materials are tailored to withstand harsh environmental conditions, including exposure to UV radiation, temperature variations, and automotive fluids, thereby ensuring long-term durability and performance in exterior automotive components, such as outside mirror seals.

### Background

An outside mirror of a vehicle is positioned on the outer front side surface of the vehicle to allow a driver to ensure a rear view. However, in electric vehicles, wind noise can be generated by the outside mirror. As illustrated in FIGS. 1 and 2, a solution has been proposed to prevent this wind noise by providing a rubber seal around the outside mirror.

However, while the outside mirror is being folded and unfolded, the rubber seal of the outside mirror may make the friction with each member (see FIG. 2; a case front member made of ASA material interferes with the rubber seal of the outside mirror when the outsider mirror is unfolded, and a scalp (including an ABS material) member interferes with the rubber seal of the outside mirror when the outside mirror is folded). This friction can cause abnormal noise or lead to abrasion of the rubber seal of the outside mirror.

In general, the rubber seal of the outside mirror is prepared by blending Styrene-Ethylene-Butadiene-Styrene (SEBS), which is a thermoplastic elastomer composition, and polypropylene (PP) which is thermoplastic. To address issues such as abnormal noise and abrasion, it is essential to ensure abrasion resistance and the low friction characteristic in the material. To this end, a slip agent may be considered. However, when the slip agent is increased, the double-injection property with PP may be degraded, hardness may be increased, so abrasion is increased, and the change of the storage modulus at the lower temperature may be increased.

Accordingly, the physical property of the rubber seal of the outside mirror may be maintained while the double-injection property with the PP is increased, the hardness is decreased, and the change in the storage modulus at the lower temperature is decreased.

### SUMMARY

The present disclosure has been made to solve the above-mentioned problems occurring in the prior art while advantages achieved by the prior art are maintained intact.

An aspect of the present disclosure provides preparing a thermoplastic elastomer composition, which shows higher double-injection property with the PP, lower hardness, and the lower change in the storage modulus at the lower temperature, by mixing a proper content of a slip agent in a thermoplastic elastomer and a thermoplastic vulcanizate (TPV).

The technical problems to be solved by the present disclosure are not limited to the aforementioned problems, and any other technical problems not mentioned herein will be clearly understood from the following description by those skilled in the art to which the present disclosure pertains.
(1) The present disclosure includes thermoplastic elastomer composition that includes a styrene-based thermoplastic elastomer in an amount of 100 parts by weight, a siloxane-based additive in an amount ranging from 25 parts by weight to 55 parts by weight, an amide-based slip agent in an amount ranging from 1 weight part to 2.5 parts by weight, and a thermoplastic vulcanizate in an amount ranging from 50 parts by weight to 300 parts by weight.
(2) The present disclosure provides the thermoplastic elastomer composition according to (1), in which the thermoplastic vulcanizate contains an ethylene propylene diene monomer (EPDM) and a polypropylene resin.
(3) The present disclosure provides the thermoplastic elastomer composition according to (1) or (2), in which siloxane-based additive contains a siloxane-based compound and a polypropylene resin.
(4) The present disclosure provides the thermoplastic elastomer composition according to (3), in which the siloxane-based additive contains a siloxane-based compound in an amount ranging from 3 wt % to 20 wt %.
(5) The present disclosure provides the thermoplastic elastomer composition according to any one of (1) to (4), in which the styrene-based thermoplastic elastomer contains a styrene-ethylene-butadiene-styrene (SEBS).
(6) The present disclosure provides the thermoplastic elastomer composition according to (5), in which the styrene-based thermoplastic elastomer contains a styrene in an amount ranging from 20 wt % to 50 wt %.
(7) The present disclosure provides the thermoplastic elastomer composition according to any one of (1) to (6), in which the siloxane-based additive is contained in an amount ranging from 30 parts by weight to 45 parts by weight, based on 100 parts by weight of the styrene-based thermoplastic elastomer.
(8) The present disclosure provides the thermoplastic elastomer composition according to any one of (1) to (7), in which the amide-based slip agent is contained in an amount ranging from 1.2 parts by weight to 2 parts by weight, based on 100 parts by weight of the styrene-based thermoplastic elastomer.
(9) The present disclosure provides the thermoplastic elastomer composition according to any one of (1) to (7), in which the thermoplastic vulcanizate is contained in an amount ranging from 100 parts by weight to 200 parts by weight, based on 100 parts by weight of the styrene-based thermoplastic elastomer.
(10) The present disclosure provides the thermoplastic elastomer composition according to any one of (1) to (7), in which the thermoplastic elastomer composition contains at most 5 wt % of a polypropylene resin.
(11) The present disclosure provides a molded product comprising the thermoplastic elastomer composition of any one of claim 1 to claim 10.

In some embodiments, a thermoplastic elastomer composition comprises a styrene-based thermoplastic elastomer in an amount of about 100 parts by weight, a siloxane-based additive in an amount ranging from about 25 parts by weight to about 55 parts by weight, an amide-based slip agent in an amount ranging from about 1 part by weight to about 2.5 parts by weight, and a thermoplastic vulcanizate in an amount ranging from about 50 parts by weight to about 300 parts by weight. The thermoplastic vulcanizate may comprise an ethylene propylene diene monomer (EPDM) and a polypropylene resin. The siloxane-based additive may comprise a siloxane-based compound and a polypropylene resin, with the siloxane-based compound provided in an amount ranging from 3 wt % to 20 wt %. The styrene-based thermoplastic elastomer may comprise a styrene-ethylene-butadiene-styrene (SEBS), with the styrene content ranging from 20 wt % to 50 wt %. The siloxane-based additive may be present in an amount ranging from about 30 parts by weight to about 45 parts by weight, based on about 100 parts by weight of the styrene-based thermoplastic elastomer. The amide-based slip agent may be present in an amount ranging from about 1.2 parts by weight to about 2 parts by weight, based on about 100 parts by weight of the styrene-based thermoplastic elastomer. The thermoplastic vulcanizate may be present in an amount ranging from about 100 parts by weight to about 200 parts by weight, based on about 100 parts by weight of the styrene-based thermoplastic elastomer. Additionally, the thermoplastic elastomer composition may comprise at most 5 wt % of the polypropylene resin.

In some embodiments, a thermoplastic elastomer composition comprises a styrene-ethylene-butadiene-styrene (SEBS) in an amount of about 100 parts by weight, a siloxane-based additive comprising a siloxane-based compound and a polypropylene resin in an amount ranging from about 30parts by weight to about 45 parts by weight, an amide-based slip agent in an amount ranging from about 1.2 parts by weight to about 2 parts by weight, and a thermoplastic vulcanizate comprising an ethylene propylene diene monomer (EPDM) and a polypropylene resin in an amount ranging from about 100 parts by weight to about 200 parts by weight. This thermoplastic elastomer composition may also comprise at most about 5 wt % of the polypropylene resin.

In some embodiments, a thermoplastic elastomer composition comprises a styrene-based thermoplastic elastomer in an amount of about 100 parts by weight, a siloxane-based additive in an amount of about 45 parts by weight, an amide-based slip agent in an amount of about 2 parts by weight, and a thermoplastic vulcanizate in an amount of about 100 parts by weight. The styrene-based thermoplastic elastomer may comprise a styrene-ethylene-butadiene-styrene (SEBS). The siloxane-based additive may comprise a siloxane-based compound and a polypropylene resin. The thermoplastic vulcanizate may comprise an ethylene propylene diene monomer (EPDM) and a polypropylene resin. Additionally, the thermoplastic elastomer composition may comprise at most 5 wt % of the polypropylene resin.

In some embodiments, a molded product comprises the thermoplastic elastomer composition of the first embodiment. An outside mirror of a vehicle may comprise the thermoplastic elastomer composition of the second embodiment. Furthermore, a vehicle may comprise the thermoplastic elastomer composition of the first embodiment.

As discussed, the method and system suitably include use of a controller or processer.

In another embodiment, vehicles and their exterior mirrors are provided, comprising a composition as disclosed herein.

### BRIEF DESCRIPTION OF THE DRAWINGS

The above and other objects, features and advantages of the present disclosure will be more apparent from the following detailed description taken in conjunction with the accompanying drawings:

FIG. 1 is a view schematically illustrating an outside mirror for a vehicle.

FIG. 2 is a view illustrating a cross-section taken along line A-A′ of FIG. 1.

FIG. 3 is a photograph obtained by capturing a surface of a rubber seal of an outside mirror including a thermoplastic elastomer composition according to comparative example 6.

FIG. 4 is a photograph obtained by capturing a surface of a rubber seal of an outside mirror including a thermoplastic elastomer composition according to comparative example 7.

FIG. 5 is a graph illustrating a measurement result, after measuring a motion friction coefficient by moving a thermoplastic elastomer composition according to example 1 to example 4 and comparative example 9 in one direction while making the friction with a material forming an outer appearance of a side view mirror, containing an ASA material, and EMBO patterned.

FIG. 6 is a graph illustrating a measurement result, after measuring a motion friction coefficient by moving a thermoplastic elastomer composition according to example 1 to example 4 and comparative example 9 in one direction while making the friction with an ABS material forming an outer appearance of a side view mirror.

### DETAILED DESCRIPTION

Hereinafter, the present disclosure will be described in more detail for the understanding of the present disclosure.

In this case, terms and words used in the present specification and the claims shall not be interpreted as commonly-used dictionary meanings, but shall be interpreted as to be relevant to the technical scope of the invention based on the fact that the inventor may properly define the concept of the terms to explain the invention in best ways.

The terms used in the present disclosure are provided only for the illustrative purpose, and the present disclosure is not limited thereto. The singular forms are intended to include the plural forms unless the context clearly indicates otherwise.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

### Thermoplastic Elastomer Composition

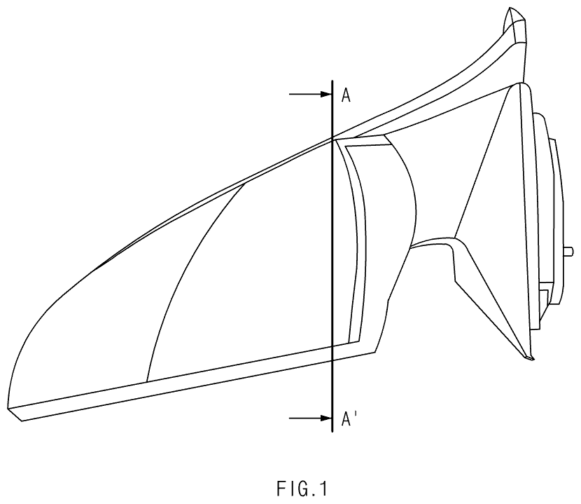

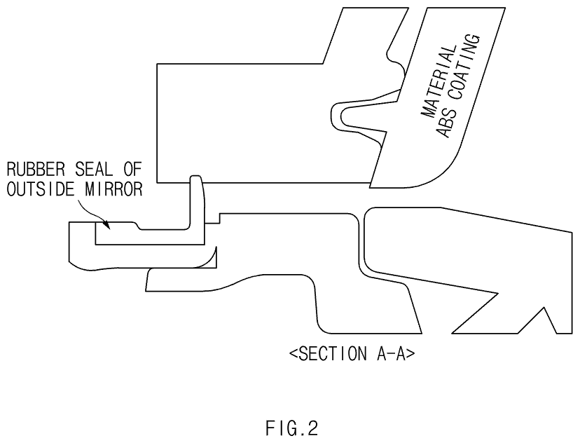

The outside mirror for the vehicle is positioned at an outer front side surface of the vehicle to allow a driver to ensure a rear view. However, as the vehicle is electrified, a wind sound is introduced through the outside mirror. Accordingly, as illustrated in FIGS. 1 and 2, there has been suggested a manner to prevent the wind sound from being introduced through the outside mirror by providing the rubber seal of the outside mirror.

However, while the outside mirror is being folded and unfolded, the rubber seal of the outside mirror may make the friction with each member (see FIG. 2; a case front member (ASA material) interferes with the rubber seal of the outside mirror when the outsider mirror is unfolded, and a scalp (including an ABS material) member interferes with the rubber seal of the outside mirror when the outside mirror is folded) constituting the outside mirror, so the abnormal noise is caused or the rubber seal of the outside mirror may be abraded.

In general, the rubber seal of the outside mirror is prepared by blending Styrene-Ethylene-Butadiene-Styrene (SEBS) which is a thermoplastic elastomer composition, and polypropylene (PP) which is thermoplastic. To solve the above-described issues of the abnormal noise or the abrasion issue, the abrasion resistance and the low friction characteristic need to be ensured in the characteristic of the material. To this end, a slip agent may be considered to be provided. However, when the slip agent is increased, the double-injection property with PP may be degraded, hardness may be increased, so abrasion is increased, and the change of the storage modulus at the lower temperature may be increased.

According to an embodiment of the present disclosure, the thermoplastic elastomer composition includes a styrene-based thermoplastic elastomer in an amount of 100 parts by weight (parts by weight); a siloxane-based additive in an amount ranging from 25 parts by weight to 55 parts by weight; an amide-based slip agent in an amount ranging from 1 weight part to 2.5 parts by weight; and a thermoplastic vulcanizate in an amount ranging from 50 parts by weight to at most 300 parts by weight.

According to an embodiment of the present disclosure, the thermoplastic elastomer composition shows a higher double injection property with respect to a PP and a lower stiffness, and a lower change in storage modulus at a lower temperature, as a proper amount of a siloxane-based additive, a proper amount of a slip agent, and a proper amount of thermoplastic vulcanizate (TPV), are mixed with a thermoplastic styrenic elastomer (TPS).

Hereinafter, components constituting the thermoplastic elastomer composition will be described in detail.

### 1. Styrene-Based Thermoplastic Elastomer

According to an embodiment of the present disclosure, the styrene-based thermoplastic elastomer may apply elasticity to the thermoplastic elastomer composition.

According to an embodiment of the present disclosure, the styrene-based thermoplastic elastomer may be a styrene-ethylene-butadiene-styrene (SEBS) rubber. In this case, the styrene-based thermoplastic elastomer may contain styrene provided in an amount ranging from 20% by weight (wt %) to 50 wt %. In detail, the styrene-based thermoplastic elastomer may contain styrene in an amount of at least 21 wt %, at least 22 wt %, at least 23 wt %, at least 24 wt %, or at least 25 wt %, and in an amount at most 48 wt %, at most 46 wt %, at most 44 wt %, at most 42 wt %, or at most 40 wt %. When the range is satisfied, the thermoplastic elastomer composition may have a mechanical property which is more enhanced, and a lower compression set.

According to an embodiment of the present disclosure, the styrene-based thermoplastic elastomer may be contained in an amount ranging from 20 wt % to 32 wt %, in the thermoplastic elastomer composition. In detail, the styrene-based thermoplastic elastomer may be contained in an amount of at least 21 wt %, at least 22 wt %, at least 23 wt %, at least 24 wt % or at least 25 wt % in the thermoplastic elastomer composition. In addition, the styrene-based thermoplastic elastomer may be contained in an amount of at most 31 wt %, at most 30 wt %, at most 29 wt %, at most 28 wt %, or at most 27 wt %. When the range is satisfied, the thermoplastic elastomer composition may have elasticity at a proper level.

### 2. Siloxane-Based Additive

According to an embodiment of the present disclosure, the siloxane-based additive may apply abrasion resistance to the thermoplastic elastomer composition.

According to an embodiment of the present disclosure, the siloxane-based additive may be a master batch which contains a siloxane-based compound and a polypropylene resin. The master batch, which contains polypropylene as a base resin, may be obtained by mixing siloxane-based compound with a polypropylene resin, such that the siloxane-based compound is uniformly distributed.

According to an embodiment of the present disclosure, the siloxane-based compound may be polydialkylsiloxane. In detail, the siloxane-based compound may include at least one type of material selected from the group consisting of polydimethylsiloxane, polydiethylsiloxane, polydipropylsiloxane, and polydibutylsiloxane. Representatively, the siloxane-based compound may be polydimethylsiloxane. Meanwhile, the siloxane-based compound may have a molecular weight of at least 200,000. When the above range is satisfied, the siloxane-based compound may apply an excellent abrasion resistance to the thermoplastic elastomer composition.

According to an embodiment of the present disclosure, the siloxane-based compound may be contained in an amount ranging from 40 wt % to 60 wt %, based on the entire portion of the siloxane-based additive. In detail, the siloxane-based compound may be contained in an amount of at least 41 wt %, at least 42 wt %, at least 43 wt %, at least 44 wt % or at least 45 wt %, and may be contained in an amount of at most 59 wt %, at most 58 wt %, at most 57 wt %, at most 56 wt %, or at most 55 wt %. When the range is satisfied, the thermoplastic elastomer composition may have a PP double injection property more improved and a lower compression set.

According to an embodiment of the present disclosure, the thermoplastic elastomer composition may contain the siloxane-based additive in an amount ranging from 25 parts by weight to 55 parts by weight, based on 100 parts by weight of the styrene-based thermoplastic elastomer. In detail, the thermoplastic elastomer composition may contain, based on 100 parts by weight of the styrene-based thermoplastic elastomer, the siloxane-based additive in an amount of at least 26 parts by weight, at least 27 parts by weight, at least 28 parts by weight, at least 29 parts by weight, or at least 30 parts by weight. In addition, the thermoplastic elastomer composition may contain, based on 100 parts by weight of the styrene-based thermoplastic elastomer, the siloxane-based additive in an amount of at most 53 parts by weight, at most 51 parts by weight, at least 49 parts by weight, at least 47 parts by weight, or at least 45 parts by weight. When the siloxane-based additive is contained in an amount under the above range, the surface modifying effect is weak. Accordingly, the abrasion resistance of the thermoplastic elastomer composition may be degraded. When the siloxane-based additive is contained in an amount exceeding the above range, the appearance characteristics may degrade due to incompatibility among the components of the thermoplastic elastomer composition.

### 3. Amide-Based Slip Agent

According to an embodiment of the present disclosure, the amide-based slip agent may apply a slip property to the thermoplastic elastomer composition.

According to an embodiment of the present disclosure, the amide-based slip agent may contain an amide-based compound, and the amide-based compound may contain at least one type of material selected from the group consisting of behenamide, crucamide, oleamide, and octadecanamide. Representatively, the amide-based compound may contain oleamide (Cl₈H₃₅ON)

According to an embodiment of the present disclosure, the thermoplastic elastomer composition may contain the amide-based slip agent in an amount ranging from 1 parts by weight to 2.5 parts by weight, based on 100 parts by weight of the styrene-based thermoplastic elastomer. In detail, the thermoplastic elastomer composition may contain, based on 100 parts by weight of the styrene-based thermoplastic elastomer, the amide-based slip agent in an amount of at least 1.05 parts by weight, at least 1.1 parts by weight, at least 1.15 parts by weight, or at least 1.2 parts by weight. In addition, the thermoplastic elastomer composition may contain, based on 100 parts by weight of the styrene-based thermoplastic elastomer, the amide-based slip agent in an amount of at most 2.4 parts by weight, at most 2.3 parts by weight, at least 2.2 parts by weight, at least 2.1 parts by weight, or at least 2 parts by weight. When the amide-based slip agent is contained in an amount under the above range, the surface modifying effect is weak. Accordingly, the slip property of the thermoplastic elastomer composition may be degraded. When the siloxane-based additive is contained in an amount exceeding the above range, the characteristic of the outer appearance of the thermoplastic elastomer composition may be degraded.

### 4. Thermoplastic Vulcanizate

According to an embodiment of the present disclosure, the thermoplastic vulcanizate may ensure the compression set and the hardness of the thermoplastic elastomer composition at a proper level.

According to an embodiment of the present disclosure, the thermoplastic vulcanizate may be prepared by dynamically vulcanizing the mixture including ethylene propylene diene monomer (EPDM) and a polypropylene resin, in the form of a vulcanizate.

According to an embodiment of the present disclosure, the thermoplastic vulcanizate has shore A hardness ranging from 45 to 60.

According to an embodiment of the present disclosure, the thermoplastic elastomer composition may contain the thermoplastic vulcanizate in an amount ranging from 50 parts by weight to 300 parts by weight, based on 100 parts by weight of the styrene-based thermoplastic elastomer. In detail, the thermoplastic elastomer composition may contain, based on 100 parts by weight of the styrene-based thermoplastic elastomer, the thermoplastic vulcanizate in an amount of at least 60 parts by weight, at least 70 parts by weight, at least 80 parts by weight, at least 90 parts by weight, or at least 100 parts by weight. In addition, the thermoplastic elastomer composition may contain, based on 100 parts by weight of the styrene-based thermoplastic elastomer, the thermoplastic vulcanizate in an amount of at most 280 parts by weight, at most 260 parts by weight, at least 240 parts by weight, at least 220 parts by weight, or at least 200 parts by weight. When the thermoplastic vulcanizate is contained in an amount under the above range, the compression set of the thermoplastic elastomer composition may be degraded. When the thermoplastic vulcanizate is contained in an amount exceeding the above range, the hardness of the thermoplastic elastomer composition may be increased unnecessarily.

### 5. Polypropylene Resin

According to an embodiment of the present disclosure, the polypropylene resin contained in the thermoplastic elastomer composition may be referred to as a polypropylene resin additionally contained and/or a polypropylene resin contained in siloxane-based additive and a polypropylene resin contained in the thermoplastic vulcanizate, in addition to components, which are the styrene-based thermoplastic elastomer, the siloxane-based additive, the amide-based slip agent, and the thermoplastic vulcanizate, constituting the thermoplastic elastomer composition.

In other words, when the polypropylene resin is additionally contained in addition to the components constituting the thermoplastic elastomer composition, the polypropylene resin contained in the thermoplastic elastomer composition may be referred to as the polypropylene resin additionally contained and/or the polypropylene resin contained in the siloxane-based additive and the polypropylene resin contained in the thermoplastic vulcanizate. When the polypropylene resin is not additionally contained in addition to the components constituting the thermoplastic elastomer composition, the polypropylene resin contained in the thermoplastic elastomer composition may be referred to as the polypropylene resin contained in the siloxane-based additive, and the polypropylene resin contained in the thermoplastic vulcanizate.

According to an embodiment, the thermoplastic elastomer composition may contain the polypropylene resin in an amount of at least 5 wt %, and in detail, in an amount ranging from 0.5 wt % to 4.5%, based on the entire portion of the thermoplastic elastomer composition.

### 6. Other Additives

According to an embodiment of the present disclosure, the thermoplastic elastomer composition may contain other additives. The additives may include at least one type of a material selected from the group consisting of a plasticizer, a filler, a UV stabilizer, a hydrolysis stabilizer, a release agent, an antistatic agent, a cross linker, an antibacterial agent, a processing aid, a metal inactivator, a suppression agent, a frictional resistance agent, and an abrasion resistance agent.

The additives may include various additives as long as the additives are used in the technical field of the present disclosure. In addition, those skilled in the art may select additives included in the present disclosure according to purposes.

### Molded Product

The present disclosure provides a molded product including the thermoplastic elastomer composition. For example, the molded product may be applied to various industrial fields, such as various electrical and electronic products and vehicle parts. For example, the molded product may be applied to the rubber seal of the outside mirror for the vehicle, as illustrated in FIG. 2.

When the thermoplastic elastomer composition according to an embodiment of the present disclosure is applied to the rubber seal of the outside rubber for the vehicle, as illustrated in FIGS. 1 and 2, the thermoplastic elastomer composition may ensure excellent properties in a slip property, a compression set, a PP adhesion performance, and abrasion resistance at lower hardness (the hardness of at most 30 shore A). Accordingly, the thermoplastic elastomer composition according to an embodiment of the present disclosure may improve a stick slip phenomenon without causing the abnormal noise in relation to a material such as ABS or ASA.

Hereinafter, an embodiment of the present disclosure will be described in detail such that those skilled in the art may easily reproduce the embodiment of the present disclosure. However, the present disclosure may be implemented in various forms, and is not limited to an embodiment described herein.

### Examples and Comparative Examples

The specifications of ingredients used in an example of the present disclosure and the comparative example are as follows.

(A) Polypropylene resin: There was used the polypropylene resin, which is classified as an HSPP block copolymer and has a melting index of at most 1 g/10 min., elongation of at least 600%, the hardness having the scale ranging from at least 80 R to at most 90 R, and the melting point of at least 152° C. to at most 156° C.

(B) Styrene-based thermoplastic elastomer There was used the styrene-ethylene-butylene-styrene (SEBS) rubber which has 33% of styrene, a specific gravity of at least 0.91, and a toluene viscosity (20 wt%, 25° C.) ranging from 1500 cp to 2500 cP.

(C) Siloxane-based additive There was used the siloxane-based additive which is the mixture of a homopolypropylene resin having a melt flow index of 12 and an ultra-high molecular weight (UHMW) siloxane compound, and contains a master batch including 50% of a siloxane compound.

(D) Amide-based slip agent There was used an amide-based additive which is an amide-based material derived from a fatty acid, has at least 97% of amide, an iodine number of 80% to 90%, and a melting point ranging from 71° C. to 76° C.

(E) Thermoplastic vulcanizate There was used the thermoplastic vulcanizate which is obtained by dynamically vulcanizing the mixture of EPDM and a polypropylene resin, contains 39 wt % of EPDM, the hardiness of Shore A ranging from 45 to 60, and has a melt flow index (230° C.; 10 kg) of at most 80, and a melting point of 153° C.

(F) UV stabilizer: There was used, as the UV stabilizer, the mixture of an amine-based light stabilizer (HALS: UV-944) having a melting point ranging from 110° C. to 130° C. and a molecular weight ranging from 2100 g/mol to 3000 g/mol, and a UV absorber (UV-326) having a melting point ranging 137° C. to 142° C. and a molecular weight of 315.

(G) Plasticizer There was, as a plasticizer, a high molecular weight paraffin oil which has a specific gravity of 0.87, a flash point of at least 280° C., and a kinematic viscosity (40° C.) value ranging 160 cp to 190 cp.

(H) Filler There was used, as a filler, which contains heavy calcium carbonate having an average particle diameter of 6.5 micrometers.

Thermoplastic elastomer (TPS): There was used, as a thermoplastic elastomer (TPS), a mixture of polypropylene resin and styrene-ethylene-butylene-styrene (SEBS) rubber without containing the thermoplastic vulcanizer.

The ingredients are mixed at the temperature ranging from 150° C. to 200° C. through an extruder with the ingredient and the content described in table 1 and table 2, and cut, thereby fabricating the thermoplastic elastomer composition in the form of a pellet.

### Experimental Example 1—Measurement of Physical Property

Pellets prepared in the example and the comparative example were extruded and injected to prepare a specimen, and physical properties were measured as follows and then described in Tables 1 and 2.
Hardness (shore A): In accordance with ISO 7619, the hardness was measured using TECLOC K's GC610 STAND for Durometer and Mitutoyo's Shore hardness meter Type A.
100% Modulus: In accordance with ISO 37, after the specimen was pulled by the rubber UTM (DUT-500C) equipment at the temperature of 25° C., and at the crosshead speed of 500 mm, the tensile stress (100% modulus) was measured when the specimen was 100% stretched.
Tensile strength: In accordance with ISO 37, after the specimen was pulled by the rubber UTM (DUT-500C) equipment at the temperature of 25° C., and at the crosshead speed of 500 mm, the tensile strength was measured at a point in which the specimen is cut.
Elongation: In accordance with ISO 37, the elongation was measured at a point in which the specimen is cut, after the specimen was pulled by the rubber UTM (DUT-500C) equipment at the temperature of 25° C., and at the crosshead speed of 500 mm/min.
Compression set: in accordance with ISO 815, the specimen was compressed by 25% and left in an oven at the temperature of 70° C. for 22 hours, the compression was released, and the test was performed under the condition of leaving the specimen at the temperature of 25° C. for 30 minutes. The thickness of the specimen was measured before and after an experiment was measured, to calculate the compression set through following Equation 1.

$$Compression set = \frac{{H}_{0} - {H}_{2}}{{H}_{0} - {H}_{1}} \times 100 \% \qquad Equation 1$$

In Equation 1, H₀ denotes the thickness of the specimen before the compression, H₁ denotes the thickness of the specimen in compression, and H₂ denotes the thickness of the specimen after the compression. In the present disclosure, the lower compression set showed excellent evaluation.
Weight change after glass abrasion (abrasion resistance): the specimen was repeatedly abraded using a glass edge at 2500 times under the condition of the load of 500 g, and the change in the weight of the specimen was measured. The great change in the weight of the specimen refers to the degradation of the abrasion resistance.
Stop friction coefficient and motion friction coefficient: Two test specimens having the size of 5 mm×100 mm were gathered with respect to each example/comparison example, and the stop friction coefficient and the motion friction coefficient of the two specimens were measured after the two specimens were moved to 200 mm under the condition of the load of 1 kg and the test speed of 50 mm/min. The motion friction coefficient was measured in the section between 50 mm to 150 mm and the average of the maximum motion friction coefficient and the minimum motion friction coefficient were measured. The lower motion friction coefficient refers to an excellent slip property.
PP adhesion performance: A tensile specimen for evaluating the adhesion performance was prepared by injecting the relevant material and bonding the relevant material to the PP specimen. In accordance with ISO 37, after the specimen was pulled by the rubber UTM (DUT-500C) equipment at the temperature of 25° C., and at the crosshead speed of 500 mm, the adhesion performance of the specimen was measured. A higher tensile stress when the PP specimen is separated from the relevant material refers to more excellent adhesion performance.

TABLE 1

| | | Example | | | |
|---|---|---|---|---|---|
| | | 1 | 2 | 3 | 4 |
| Composition | polypropylene resin | — | — | — | — |
| | (parts by weight) | | | | |
| | styrene-based | 100 | 100 | 100 | 100 |
| | thermoplastic elastomer | | | | |
| | (parts by weight) | | | | |
| | siloxane-based additive | 30 | 30 | 45 | 30 |
| | (parts by weight) | | | | |
| | amide-based slip agent | 1.2 | 2 | 2 | 2 |
| | (parts by weight) | | | | |
| | thermoplastic vulcanizate | 200 | 150 | 100 | 200 |
| | (parts by weight) | | | | |
| | UV stabilizer | 2 | 2 | 2 | 2 |
| | (parts by weight) | | | | |
| | plasticizer | 165 | 165 | 165 | 165 |
| | (parts by weight) | | | | |
| | filler (parts by weight) | 30 | 30 | 30 | 30 |
| physical | hardness (shore A) | 33 | 31 | 31 | 34 |
| property | 100% modulus (Mpa) | 0.7 | 0.7 | 0.8 | 0.8 |
| | tensile strength (Mpa) | 3.2 | 2.6 | 3.0 | 3.1 |
| | elongation (%) | 527 | 518 | 655 | 488 |
| | compression set (%) | 29 | 35 | 37 | 32 |
| | weight change after | 0 | 0 | 0 | 0 |
| | glass abrasion (mg) | | | | |
| | stop friction coefficient | 2.6 | 2.5 | 2.2 | 2.2 |
| | motion friction | 2.7 | 2.6 | 2.3 | 2.5 |
| | coefficient | | | | |
| | PP adhesion | 8.1 | 8.8 | 10.9 | 8.1 |
| | performance (Kgf/cm²) | | | | |

TABLE 2

| | | Comparative example | | | | | | | | |
|---|---|---|---|---|---|---|---|---|---|---|
| | | 1 | 2 | 3 | 4 | 5 | 6 | 7 | 8 | 9 |
| composition | polypropylene resin | 25 | 15 | 15 | 25 | 15 | — | — | — | thermoplastic |
| | (parts by weight) | | | | | | | | | elastomer |
| | styrene-based | 100 | 100 | 100 | 100 | 100 | 100 | 100 | 100 | (I) |
| | thermoplastic elastomer | | | | | | | | | |
| | (parts by weight) | | | | | | | | | |
| | siloxane-based additive | — | — | 20 | — | 20 | 45 | 60 | 45 | |
| | (parts by weight) | | | | | | | | | |
| | amide-based slip agent | — | — | — | 2 | 2 | 2 | 2 | 3 | |
| | (parts by weight) | | | | | | | | | |
| | thermoplastic | — | 200 | — | — | — | 350 | 100 | 100 | |
| | vulcanizate (parts by | | | | | | | | | |
| | weight) | | | | | | | | | |
| | UV stabilizer (parts by | 2 | 2 | 2 | 2 | 2 | 2 | 2 | 2 | |
| | weight) | | | | | | | | | |
| | plasticizer (parts by | 165 | 165 | 165 | 165 | 165 | 165 | 165 | 165 | |
| | weight) | | | | | | | | | |
| | filler (parts by weight) | 30 | 30 | 30 | 30 | 30 | 30 | 30 | 30 | |
| physical | hardness (shore A) | 29 | 35 | 30 | 27 | 31 | 38 | 34 | 31 | 32 |
| property | 100% modulus (Mpa) | 0.6 | 1 | 0.7 | 0.6 | 0.7 | 1.3 | 1 | 0.8 | 0.7 |
| | tensile strength (Mpa) | 4.5 | 3.1 | 5.2 | 4.4 | 4.8 | 3.6 | 3.9 | 3.6 | 5.6 |
| | Elongation (%) | 850 | 450 | 895 | 815 | 885 | 430 | 690 | 682 | 837 |
| | compression set (%) | 42 | 26 | 43 | 44 | 46 | 29 | 39 | 39 | 46 |
| | weight change after | 29 | 40 | 8 | 19 | 2 | — | — | — | 50 |
| | glass abrasion (mg) | | | | | | | | | |
| | stop friction coefficient | 4.1 | 3.6 | 2.8 | 3.4 | 2.7 | 1.9 | 1.6 | 1.8 | 3.8 |
| | motion friction | 4.7 | 3.5 | 3 | 3.5 | 2.9 | 2.1 | 2 | 2.1 | 3.9 |
| | coefficient | | | | | | | | | |
| | PP adhesion | 7.3 | 7.1 | 8.6 | 7.2 | 8.4 | 8.1 | 11.5 | 8.2 | 7.4 |
| | performance (Kgf/cm²) | | | | | | | | | |

Referring to FIGS. 1 and 2, it may be recognized that excellent slip property, compression set, PP adhesion performance, and abrasion resistance are showed in lower hardness (at most 34 shore A) according to example 1 to example 4, in which components of the thermoplastic elastomer composition, which are the styrene-based thermoplastic elastomer, the siloxane-based additive, the amide-based slip agent, and the thermoplastic vulcanizate, are provided in a proper content, as compared to comparative example 1 to comparative example 9 in which the components of the thermoplastic elastomer composition are not provided in a proper content.

In detail, it may be recognized that comparative examples 1, 3 to 5, and 9 without thermoplastic vulcanizate showed higher compression set and lower abrasion resistance, as compared to examples.

In addition, it may be recognized that the abrasion resistance is remarkably degraded in comparative example 2, in which the siloxane-based additive and amide-based slip agent are not contained even though the thermoplastic vulcanizate is contained, as compared to examples.

It may be recognized that hardness is excessively increased, in comparative example 6, in which the thermoplastic vulcanizate is contained in excessive content.

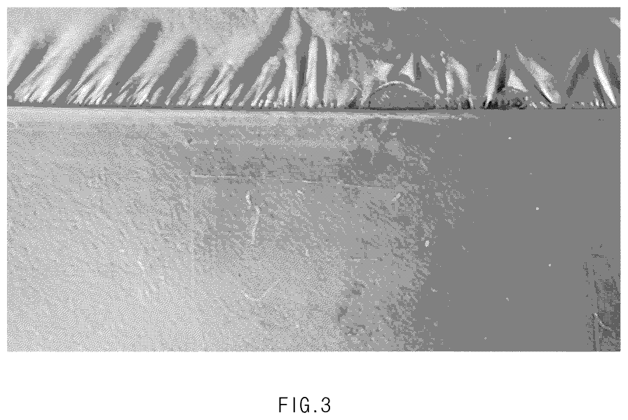

It may be recognized that as the surface of the specimen is delaminated, the outer appearance is defective, as illustrated in FIG. 3 in comparative example 7, in which the siloxane-based additive is contained in excessive content.

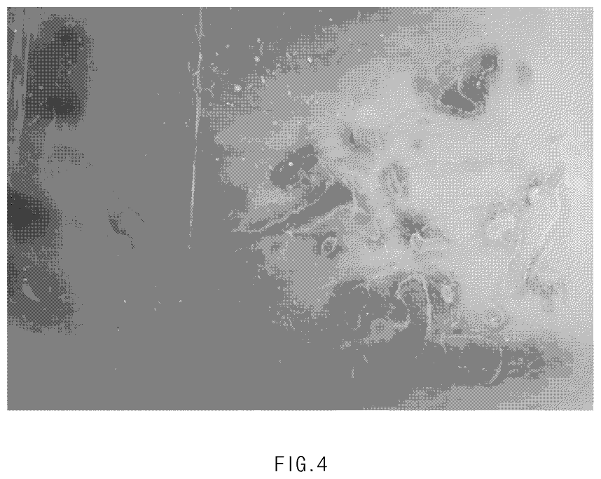

It may be recognized that as oil is transferred on the surface of the specimen, the outer appearance is defective, as illustrated in FIG. 4 in comparative example 8, in which the amide-based slip agent is contained in excessive content.

### Experimental Example 2—Improvement of Stick Slip Recognized

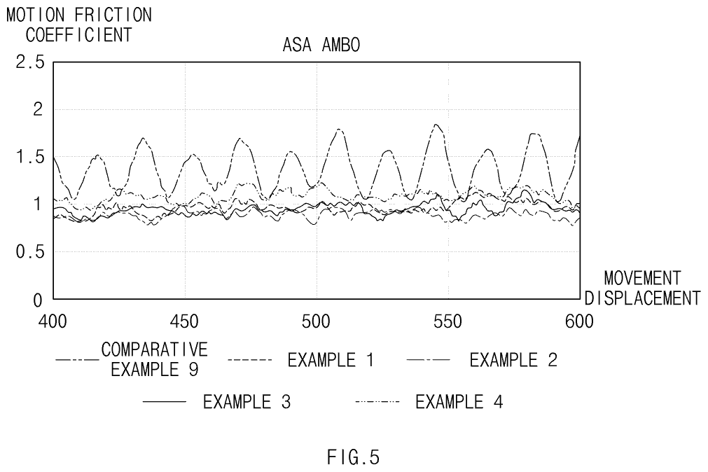

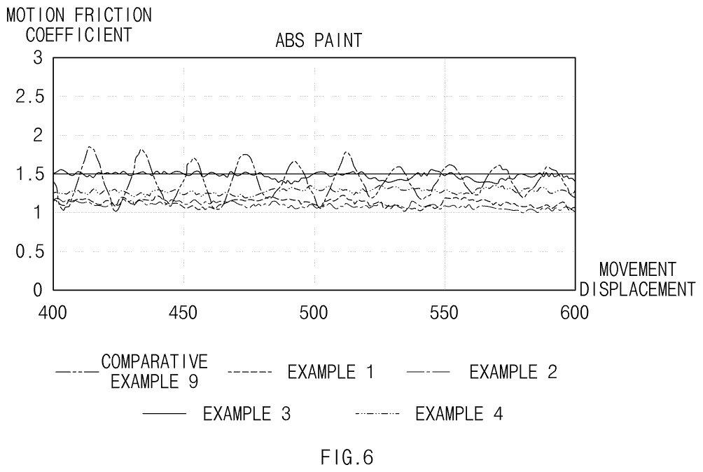

As illustrated in FIG. 2, the motion friction coefficient was measured by moving the thermoplastic elastomer composition according to example 1 to example 4 and comparative example 9 in one direction while making the friction with a material forming an outer appearance of a side view mirror, containing an ASA material EMBO patterned, and an ABS material. Then the measurement result are shown in FIGS. 5 and 6. It refers to that a stick slip phenomenon is increased, when the variation of the motion friction coefficient depending on movement displacement is increased, and refers to that the stick slip phenomenon is improved, when the variation of the motion friction coefficient is decreased. As the stick slip phenomenon is increased, the friction on the contact surface between the rubber material and the plastic material may be increased.

It may be recognized from FIGS. 5 and 6 that the stick slip phenomenon is improved, as the variation of the motion friction coefficient depending on movement displacement is decreased according to example 1 to example 4, as compared to comparative example 9 in which the thermoplastic vulcanizate is not contained.

### Experimental Example 3—Improvement of Damping Property Recognized

Regarding to the thermoplastic elastomer composition of example 3 and comparative example 9, the dynamic strain of 0.2% and a temperature sweep at 10 Hz were performed by using a TA instrument's Q850 instrument (DMA). Then, the change between the storage modulus at the temperature of 23° C. and the storage modulus at the temperature of −40° C. was calculated, and the calculation result was described in following table 3.

TABLE 3

| | DMA measurement result | | |
|---|---|---|---|
| | Storage | Storage | |
| | modulus (A) | modulus (B) | Storage modulus |
| | at temperature | at temperature | change Rate |
| | of 23° C. | of −40° C. | (B/A) |
| Example 3 | 5.5 | 42.3 | 769% |
| Comparative | 3.4 | 30.9 | 909% |
| example 9 | | | |

Referring to table 3, it may be recognized that a damping property is ensured due to the lower change rate of the storage modulus according to example 3, as compared to comparative example 9 in which the thermoplastic vulcanizate is not contained.

### Experimental Example 4—Effect Recognized After Application of Real Vehicle

The thermoplastic elastomer composition according to example 1, example 3, and comparative example 9 was applied to the rubber seal of the outside mirror as illustrated in FIGS. 1 and 2. Thereafter, the abnormal noise resulting from the rubber seal of the outside mirror was evaluated by repeating the folding and the unfolding of the outside mirror at 3,000 times. In addition, the state of the abrasion of the rubber seal of the outside mirror was evaluated by repeating the folding and the unfolding of the rubber seal of the outside mirror at 3,000 times, and the evaluation results were described in table 4.

TABLE 4

| | Material of rubber seal of outside mirror | | | |
|---|---|---|---|---|
| | | | Comparative | Comparative |
| | Example 1 | Example 3 | example 9 | example 9 |
| Application of | — | — | — | ◯ |
| lubricant | | | | |
| Occurrence | There is no | There is no | There is | There is no |
| state of | abnormal | abnormal | abnormal | abnormal |
| abnormal noise | noise | noise | noise | noise |
| Abrasion state | There is no | There is no | Abraded | There is no |
| | abrasion | abrasion | | abrasion |

Referring to table 4, it may be recognized that the abnormal noise phenomenon and the abrasion phenomenon were improved without the application of lubricant, when comparing thermoplastic elastomer composition according to example 1 and example 3 with a thermoplastic elastomer composition according to comparative example 9.

As described above, according to the present disclosure, the thermoplastic elastomer composition shows higher double-injection property with PP, lower hardness, and the lower change in the storage modulus at the lower temperature.

An outside mirror seal including the thermoplastic elastomer composition according to the present disclosure shows the higher double-injection property with the PP, lower hardness, and the lower change in the storage modulus at the lower temperature.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A thermoplastic elastomer composition comprising:
a styrene-based thermoplastic elastomer in an amount of about 100 parts by weight;
a siloxane-based additive in an amount ranging from about 25 parts by weight to about 55 parts by weight;
an amide-based slip agent in an amount ranging from about 1 weight part to about 2.5 parts by weight; and
a thermoplastic vulcanizate in an amount ranging from about 50 parts by weight to about 300 parts by weight.

2. The thermoplastic elastomer composition of claim 1, wherein the thermoplastic vulcanizate comprises an ethylene propylene diene monomer (EPDM) and a polypropylene resin.

3. The thermoplastic elastomer composition of claim 1, wherein the siloxane-based additive comprises a siloxane-based compound and a polypropylene resin.

4. The thermoplastic elastomer composition of claim 3, wherein the siloxane-based additive comprises a siloxane-based compound which is provided in an amount ranging from 3 wt % to 20 wt %.

5. The thermoplastic elastomer composition of claim 1, wherein the styrene-based thermoplastic elastomer comprises a styrene-ethylene-butadiene-styrene (SEBS).

6. The thermoplastic elastomer composition of claim 5, wherein the styrene-based thermoplastic elastomer comprises a styrene in an amount ranging from 20 wt % to 50 wt %.

7. The thermoplastic elastomer composition of claim 1, wherein the siloxane-based additive is comprised in an amount ranging from about 30 parts by weight to about 45 parts by weight, based on about 100 parts by weight of the styrene-based thermoplastic elastomer.

8. The thermoplastic elastomer composition of claim 1, wherein the amide-based slip agent is comprised in an amount ranging from about 1.2 parts by weight to about 2 parts by weight, based on about 100 parts by weight of the styrene-based thermoplastic elastomer.

9. The thermoplastic elastomer composition of claim 1, wherein the thermoplastic vulcanizate is comprised in an amount ranging from about 100 parts by weight to about 200 parts by weight, based on about 100 parts by weight of the styrene-based thermoplastic elastomer.

10. The thermoplastic elastomer composition of claim 1, wherein the thermoplastic elastomer composition comprises at most 5 wt % of the polypropylene resin.

11. A thermoplastic elastomer composition comprising:
a styrene-ethylene-butadiene-styrene (SEBS) in an amount of about 100 parts by weight;
a siloxane-based additive comprising a siloxane-based compound and a polypropylene resin, the siloxane-based additive in an amount ranging from about 30 parts by weight to about 45 parts by weight;
an amide-based slip agent in an amount ranging from about 1.2 parts by weight to about 2 parts by weight; and
a thermoplastic vulcanizate comprising an ethylene propylene diene monomer (EPDM) and a polypropylene resin, the thermoplastic vulcanizate in an amount ranging from about 100 parts by weight to about 200 parts by weight.

12. The thermoplastic elastomer composition of claim 11, wherein the thermoplastic elastomer composition comprises at most about 5 wt % of the polypropylene resin.

13. A thermoplastic elastomer composition comprising:
a styrene-based thermoplastic elastomer in an amount of about 100 parts by weight;
a siloxane-based additive in an amount of about 45 parts by weight;
an amide-based slip agent in an amount of about 2 parts by weight; and
a thermoplastic vulcanizate in an amount of about 100 parts by weight.

14. The thermoplastic elastomer composition of claim 13, wherein the styrene-based thermoplastic elastomer comprises a styrene-ethylene-butadiene-styrene (SEBS).

15. The thermoplastic elastomer composition of claim 13, wherein the siloxane-based additive comprises a siloxane-based compound and a polypropylene resin.

16. The thermoplastic elastomer composition of claim 13, wherein the thermoplastic vulcanizate comprises an ethylene propylene diene monomer (EPDM) and a polypropylene resin.

17. The thermoplastic elastomer composition of claim 13, wherein the thermoplastic elastomer composition comprises at most 5 wt % of the polypropylene resin.

18. A molded product comprising the thermoplastic elastomer composition of claim 1.

19. An outside mirror of vehicle comprising the thermoplastic elastomer composition of claim 1.

20. A vehicle comprising the thermoplastic elastomer composition of claim 1.
